(19) United States
(12) Patent Application Publication
(10) Pub. No.: US 2023/0286177 A1
(43) Pub. Date: Sep. 14, 2023

(54) SOFT ROBOTIC GRIPPER WITH A VARIABLE STIFFNESS ENABLED BY POSITIVE PRESSURE LAYER JAMMING

(71) Applicant: Ohio State Innovation Foundation, Colmbus, OH (US)

(72) Inventors: Haijun Su, Columbus, OH (US); George Crowley, Columbus, OH (US); Xianpai Zeng, Columbus, OH (US)

(21) Appl. No.: 18/114,781

(22) Filed: Feb. 27, 2023

Related U.S. Application Data
(60) Provisional application No. 63/313,825, filed on Feb. 25, 2022.

(51) Int. Cl. B25J 15/12

(52) U.S. Cl. CPC B25J 15/12

(57) ABSTRACT

A finger for a robotic gripper may include a flexible actuator, a flexible backbone, a rigid constraint frame, a plurality of jamming layers, and a jamming bag. The flexible actuator may have a proximal end, a distal end disposed opposite the proximal end, a first side, and a second side disposed opposite the first side. The flexible backbone may be coupled to the flexible actuator and disposed along the first side of the flexible actuator. The rigid constraint frame may be coupled to the flexible actuator and disposed along the second side of the flexible actuator. The jamming layers may be coupled to the flexible actuator and disposed at least partially within the rigid constraint frame. The jamming bag disposed at least partially within the rigid constraint frame and configured to apply a compressive force to the jamming layers when a positive pressure is generated within the jamming bag.

### CROSS-REFERENCE TO RELATED APPLICATIONS

This application claims benefit of U.S. Provisional Application No. 63/313,825, filed Feb. 25, 2022, incorporated herein by reference in its entirety.

### GOVERNMENT SUPPORT CLAUSE

This invention was made with government support under grant/contract number 2016445 awarded by the National Science Foundation. The government has certain rights in the invention.

### FIELD OF THE DISCLOSURE

The present disclosure relates generally to robotics and more particularly to soft robotic grippers with a variable stiffness enabled by positive pressure layer jamming.

### BACKGROUND OF THE DISCLOSURE

Soft robots are a rapidly growing field in modern robotics with a wide range of potential uses. Compared to traditional robots, soft robots have inherent compliance and are designed to undergo high strain as part of their operation [1]. Soft robots are typically fabricated from elastomeric or flexible materials with a monolithic construction [2]. Research has been done on the design of soft robots for food handling, package handling and minimally invasive surgeries, and many more applications. These designs frequently draw inspiration from octopi and elephant's trunks, whose appendages lack skeletal structure and discrete joints like those found in humans [1].

Soft robots have two main advantages over traditional, “hard” robots: safety and simplified control. Through their compliance, soft robots are inherently safer for operation around humans. Additionally, through material and design choices, some control functions of a soft robot can be handled by the robot itself. This idea is called morphological computation [2]. For example, while a “hard” robot might require several degrees of freedom and force sensors to safely pick up a small item like a box, a pneumatic soft gripper of a similar footprint could be controlled with a single solenoid valve and would conform to the box, allowing for less precise grasp planning.

However, due to their compliance, soft robots are limited in how much payload weight they can carry. Because of this, much research has been performed on technologies that can be used to vary the stiffness of soft robots. Methods for controlling stiffness can use low-melting-point alloys [3], granular jamming [4][5], layer jamming [6][7], or a number of other solutions [8]. Jamming refers to a class of variable stiffness technologies which rely on compression of a substrate in the joint to produce a locking effect through friction [8]. The substrate is commonly granules such as ground coffee, or layers such as plastic strips, and locking is often achieved by vacuum compression, although alternate methods and materials, such as tendon-based compression [5] and fiber substrates [9] have been researched.

Research has also been performed on optimized design and manufacture of soft grippers. For example, Mosadegh et al. produced an optimized soft pneumatic actuator design with 25× higher actuation speed and 8× actuation force over contemporary designs [10]. While the most commonly used method for producing soft grippers is silicone molding, increasingly, research has been done on using additive manufacturing with soft thermoplastics instead. Yap et al. discussed several different soft actuator designs printed from TPU and showed fatigue and performance testing [11]. Additive manufacturing allows for features that cannot be produced by molding such as complex internal geometry, or multi-material features like mounting hard points or sensors. For example, Hainsworth et al. utilized multi-material printing to produce a soft finger with an integrated strain gauge to measure curvature [12], and Howard et al. demonstrated granular jamming grippers which could be printed and used without further assembly [4].

A need therefore exists for improved variable stiffness soft robotic grippers and methods for grasping and manipulating objects, which may overcome one or more of the challenges associated with existing soft robotic grippers and their methods of use.

### SUMMARY OF THE DISCLOSURE

The present disclosure provides soft robotic grippers with a variable stiffness enabled by positive pressure layer jamming and related methods of using such grippers for grasping and manipulating objects.

In one aspect, a finger for a robotic gripper is provided. The finger may include a flexible actuator, a flexible backbone, a rigid constraint frame, a plurality of jamming layers, and a jamming bag. The flexible actuator may have a proximal end, a distal end disposed opposite the proximal end, a first side, and a second side disposed opposite the first side. The flexible backbone may be coupled to the flexible actuator and disposed along the first side of the flexible actuator. The rigid constraint frame may be coupled to the flexible actuator and disposed along the second side of the flexible actuator. The jamming layers may be coupled to the flexible actuator and disposed at least partially within the rigid constraint frame. The jamming bag disposed at least partially within the rigid constraint frame and configured to apply a compressive force to the jamming layers when a positive pressure is generated within the jamming bag.

In some embodiments, the flexible actuator may include a bellows. In some embodiments, the flexible actuator may include an actuator base defining the first side of the flexible actuator; and a plurality of actuator segments each extending from the base to the second side of the flexible actuator. In some embodiments, the actuator segments may be arranged in series along the base in a direction from the proximal end to the distal end of the flexible actuator. In some embodiments, the flexible actuator also may include a plurality of internal pockets defined therein, with one of the internal pockets being defined within each of the actuator segments. In some embodiments, the internal pockets may be in fluid communication with one another. In some embodiments, the flexible actuator also may include a plurality of channels defined therein, with one or more of the channels extending between the internal pockets of each adjacent pair of actuator segments. In some embodiments, the actuator segments and the actuator base may be integrally formed with one another.

In some embodiments, the flexible backbone may be formed as a sheet member coupled to the actuator base. In some embodiments, the flexible backbone and the flexible actuator may be integrally formed with one another. In some embodiments, the rigid constraint frame may include a plurality of frame segments each coupled to one of the actuator segments. In some embodiments, the frame segments and the flexible actuator may be integrally formed with one another. In some embodiments, the rigid constraint frame may define a channel extending in a direction from the proximal end to the distal end of the flexible actuator, the jamming layers may be disposed at least partially within the channel, and the jamming bag may be disposed at least partially within the channel. In some embodiments, the rigid constraint frame also may include a plurality of frame covers each coupled to one of the frame segments and extending over the channel. In some embodiments, the frame covers and the frame segments may be separately formed and coupled to one another.

In some embodiments, each of jamming layers may be coupled to one of the actuator segments. In some embodiments, the jamming layers may be disposed between the jamming bag and the actuator. In some embodiments, the finger also may include a guide layer coupled to the flexible actuator and disposed between the jamming layers and the jamming bag. In some embodiments, the guide layer may be coupled to the flexible actuator near the distal end of the flexible actuator. In some embodiments, the finger also may include a cover layer coupled to the flexible actuator and disposed between the guide layer and the jamming bag. In some embodiments, the cover layer may be coupled to the flexible actuator near the proximal end of the flexible actuator. In some embodiments, the finger also may include a first air tube coupled to an air inlet of the flexible actuator and in fluid communication with a plurality of internal pockets of the flexible actuator, with the first air tube being configured to deliver air to and withdraw air from the internal pockets to actuate the flexible actuator. In some embodiments, the finger also may include a second air tube coupled to an air inlet of the jamming bag and in fluid communication with an internal space of the jamming bag, with the second air tube being configured to deliver air to and withdraw air from the internal space to expand and contract the jamming bag. In some embodiments, the finger also may include a pressurized air source in fluid communication with the first air tube and the second air tube.

In some embodiments, the flexible actuator may be configured to be actuated between a first configuration and a second configuration. In some embodiments, the first configuration may be a curved configuration, and the second configuration may be a straight configuration. In some embodiments, the flexible actuator may be biased toward the first configuration. In some embodiments, the finger also may include an actuation spring coupled to the flexible actuator and configured to bias the flexible actuator toward the first configuration. In some embodiments, the actuation spring may be coupled to the flexible actuator near the proximal end of the flexible actuator and near the distal end of the flexible actuator. In some embodiments, the actuation spring may include a constant force spring. In some embodiments, the flexible actuator may be configured to be actuated from the first configuration toward the second configuration when a positive pressure is generated within the flexible actuator. In some embodiments, the flexible actuator and the jamming bag may be formed of a thermoplastic elastomer, and the flexible backbone and the rigid constraint frame may be formed of a thermoplastic polyester. In some embodiments, the flexible actuator and the jamming bag may be formed of thermoplastic polyurethane, and the flexible backbone and the rigid constraint frame may be formed of polyethylene terephthalate glycol.

These and other aspects and improvements of the present disclosure will become apparent to one of ordinary skill in the art upon review of the following detailed description when taken in conjunction with the several drawings and the appended claims.

### BRIEF DESCRIPTION OF THE DRAWINGS

FIG. 1 is a cross-sectional side view of a portion of a finger 107 of a robotic gripper 100 in accordance with embodiments of the disclosure, showing a flexible actuator 101, a flexible backbone 102, a rigid constraint frame 103, a plurality of jamming layers 104, a jamming bag 105, and an actuation spring 106 of the finger.

FIG. 2(a) is a perspective view of a portion of a finger 107 of a robotic gripper 100 in accordance with embodiments of the disclosure, showing a flexible actuator 101, a flexible backbone 102, a rigid constraint frame 103, and an actuation spring 106 bearing mount of the finger 107. FIG. 2(b) is a side view of the finger of FIG. 2(a), showing the finger 107 in a first configuration having a grip shape and a second configuration having an open shape. FIG. 2(c) shows a broken side view and a broken cross-sectional top view of a jamming bag 105 of the finger 107 of FIG. 2(a). FIG. 2(d) is a perspective view of a robotic gripper 100 designed for a UR5 Robot in accordance with embodiments of the disclosure, showing the robotic gripper including two of the fingers 107(a) and 107(b) of FIG. 2(a). FIG. 2(e) is a cross-sectional side view of the finger 107 of FIG. 2(a), showing the flexible actuator 101, the flexible backbone 102, the rigid constraint frame 103, the actuation spring bearing mount 108, the jamming bag 105, a plurality of jamming layers 104, and an actuation spring 106 of the finger 107. FIG. 2(f) is a detailed cross-sectional side view of a bellow 109 of the flexible actuator 101 of the finger 107 of FIG. 2(a).

FIG. 3(a) illustrates a functional cycle of the finger 107 of FIG. 2(a) including five states, showing an open state, an actuate state, a jammed state, a transport state, and a release state of the functional cycle. FIG. 3(b) shows side views of a robotic gripper 100 in accordance with embodiments of the disclosure, showing the robotic gripper 100 including two of the fingers of FIG. 2(a) in a fully closed state and in a fully open state.

FIG. 4 is a perspective view of a portion of the finger of FIG. 2(a), showing respective portions of the flexible actuator 101, the flexible backbone 102, and the rigid constraint frame 103.

FIG. 5 is a top view of portions of the finger 107 of FIG. 2(a) prior to assembly of the finger 107, indicating separate prints and post-processing in fabrication of the finger 107 in accordance with embodiments of the disclosure.

FIG. 6(a) is a plan view of a test experimental setup for testing stiffness of the finger 107of FIG. 2(a). FIG. 6(b) is a graph of average force as a function of displacement of the finger. FIG. 6(c) is a plan view of a pull-out force experimental setup for testing pull-out force for the finger of FIG. 2(a). FIG. 6(d) is a graph of average force as a function of displacement of the finger, with standard deviation and stiffness increases. FIG. 6(e) is a graph of average pull-out force as a function of jamming pressure.

FIG. 7(a) is a perspective view of a robotic gripper 100 in accordance with embodiments of the disclosure, showing the robotic gripper 100 mounted on a UR5 robot arm 110, including two of the fingers 107(a) and 107(b) of FIG. 2(a), and picking up a cup with an aluminum cylinder with layer jamming enabled. FIG. 7(b) is a perspective view of the robotic gripper of FIG. 7(a) picking up an empty cup with layer jamming disabled. FIG. 7(c) is a perspective view of the robotic gripper 100 of FIG. 7(a) picking up an aluminum block with layer jamming enabled. FIG. 7(d) is a perspective view of the robotic gripper of FIG. 7(a) picking up a bucket with layer jamming enabled.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION OF THE DISCLOSURE

In the following description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional. In some instances, well known methods, procedures, components, and circuits have not been described in detail so as not to unnecessarily obscure aspects of the embodiments.

Overview

The present disclosure provides embodiments of soft robotic grippers with a variable stiffness enabled by positive pressure layer jamming and related methods of using such grippers for grasping and manipulating objects.

In this research, a pneumatic variable stiffness soft robotic gripper was developed and fabricated in two materials using customized additive manufacturing. A novel positive layer jamming technology was developed for tuning stiffness of the gripper. Positive pressure layer jamming has a higher performance potential than conventional vacuum layer jamming because a higher pressure can be applied, approximately 1.6× higher in terms of payload capacity. Two different thermoplastics materials may be printed together to form a relatively hard backbone and a relatively soft airtight actuation bellows. The implementation of positive layer jamming is described herein, along with the additive manufacturing techniques used to produce the gripper and the test results of the final design. Experimental tests show that this soft gripper was able to vary its stiffness about 25× fold with the positive layer jamming. This work demonstrates that the positive pressure jamming offers a novel method for varying soft robot stiffness with higher payload capacity than the conventional vacuum based layer jamming technology.

Motivations and Background

Soft grippers have been shown to be effective in industrial applications for package and food handling. They have weight and simplicity advantages over traditional robots, containing a much lower number of components, and requiring less complicated control schemes. Despite these advantages, they are significantly limited in payload capacity. Integrating a variable stiffness technology into a soft gripper would provide a solution to this problem, allowing the gripper to conform to payloads when grasping them and stiffen to carry heavier loads.

While Zeng et al. [13] demonstrated a layer jamming joint with a stiffness increase of 75×, their design partially relied on a parallel beam design, which is less applicable to compact grippers. Applied to soft grippers in a smaller form factor, Wall et al. demonstrated a 3.5× and 2× stiffness increase using layer and granular jamming respectively [6]. Fiber-based jamming grippers have also shown a similar stiffness increase of 3× [9]. Other stiffness variation methods, such as Low-Melting-Point Alloys (LMPA) have been shown to increase stiffness by a factor of 477× in soft manipulators [3]. However, because LMPA activation can require approximately 10 seconds [3], jamming is desirable for applications requiring faster response times. Limited research has been performed on positive pressure jamming solutions, but it has been used with granular jamming to create a novel variable stiffness revolute joint [14]. Positive pressure has also been used in conjunction with a vacuum granular jamming gripper to forcibly eject payload from the gripper [15].

The Principle of Positive Layer Jamming

To achieve maximum stiffness variation in a soft gripper, the stiffening mechanism should be placed away from the bending axis of the gripper. Because of this, as the gripper curls, the stiffening mechanism will be required to extend by an amount proportional to its distance from the bending axis. Of the three commonly researched types of jamming (granular, fiber and layer), layer jamming has the greatest potential for extension—because the layers overlap, they can move relative to each other and still provide effective jamming. Compared to designs like the “Jamsheets” produced by Ou et al. [16], placing layers away from the bending axis maximizes peak stiffness and increases shape restoration performance.

When considering a layer jamming soft gripper, the distance between the layers and the bending axis of the gripper can at most be the thickness of the gripper. So, in order to further increase performance, other parts of the design must be considered. From prior research, it is known that layer jamming joint stiffness increases as more vacuum pressure is applied to the layers, and that the typical mode of failure (yielding) is slip between the layers [13] [17]. In characterizing Layer Jamming loading performance, Zeng et al. identified three distinct phases: Phase 1, Pre-slip, Phase 2, Transition and Phase 3, Slip [13]. In Phase 1, the layers are locked together by friction and the stiffness of the jamming joint is dependent on joint material stiffness [13]. The Transition Phase marks where the applied load exceeds the friction force between the layers and they begin to slip relative to each other [13]. Finally, the Slip Phase indicates continuous slip between the layers [13].

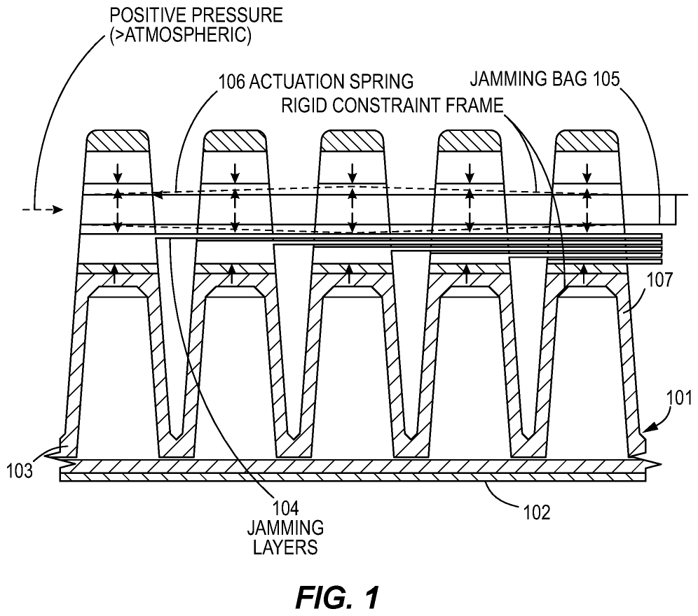

Most current layer jamming designs use vacuum to lower the pressure in the membrane containing the layers, compressing the layers at a maximum of 14.7 psi (101.4 kPa), atmospheric pressure [16]. Because atmospheric pressure cannot be increased, we propose a design wherein the jamming layers are unenclosed and compressed instead by an inflatable membrane or jamming bag. In this concept, the jamming bag can be inflated to any pressure and is only limited by the air supply and material strength of the bag. Then a higher compressive force can be applied to the layers, producing higher friction forces and raising the force required to cause the layers to slip relative to each other. To implement this design, several changes are made from vacuum layer jamming. The layers are placed in a segmented, rigid constraint frame on the top side of the gripper. The rigid constraint frame is required to react against the expansion of the jamming bag and direct the force into the layers, as shown in FIG. 1.

Design Overview

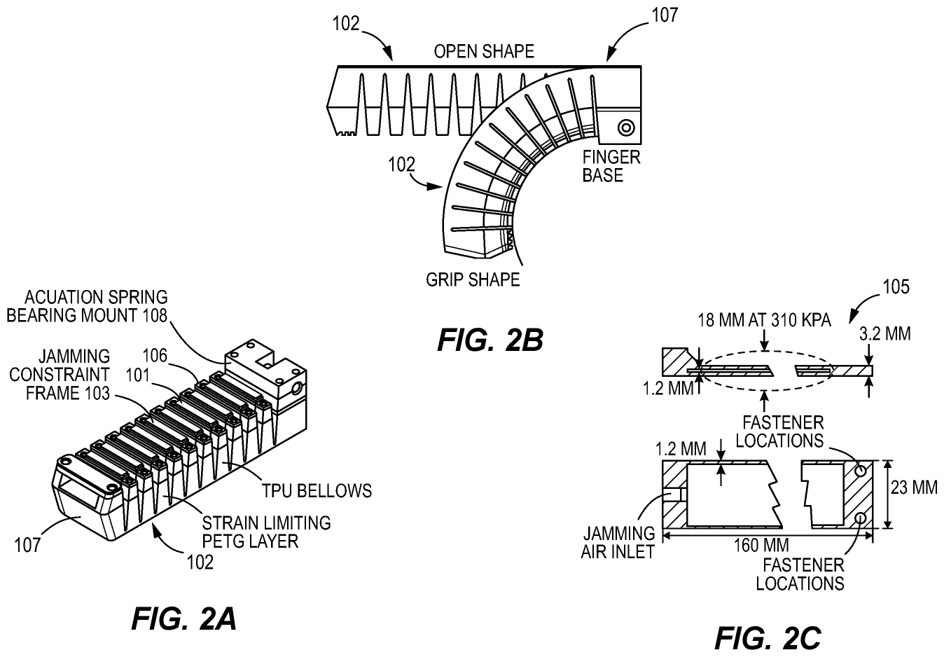

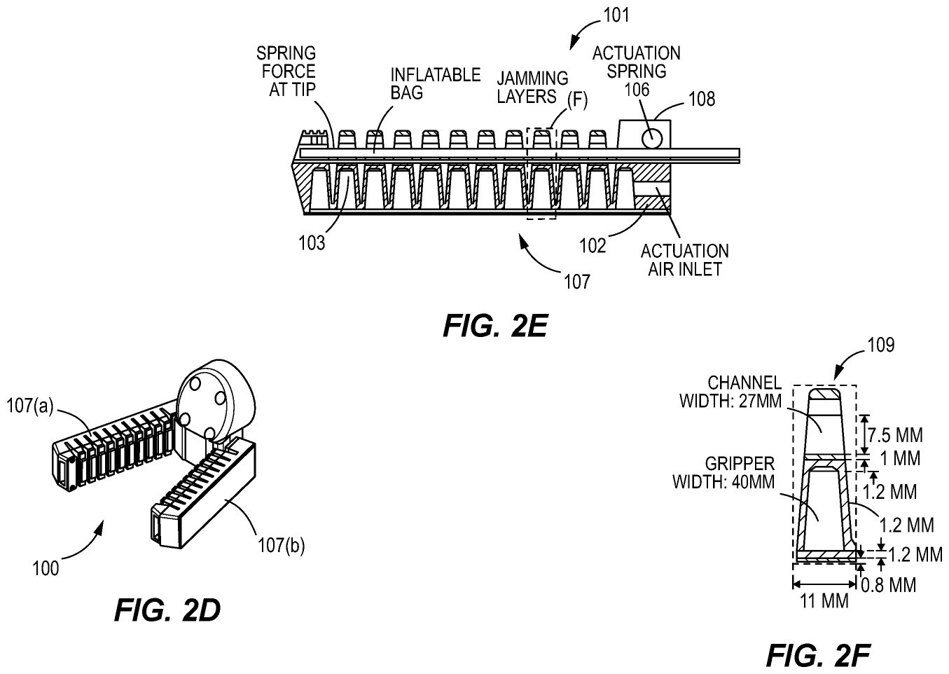

In accordance with certain embodiments of the present disclosure, the goal of a soft gripper with high stiffness variation may be approached with two solutions: novel positive layer jamming and the use of multi-material additive manufacturing. The proposed design for this gripper may consist of a thin, PETG strain limiting backbone, a soft TPU bellows used for actuation, and a PETG jamming constraint frame, which contains the jamming layers, TPU jamming bag and actuation spring, as shown in FIG. 2. While not monolithic, this gripper may primarily consist of 3D printed parts, and may require minimal assembly, particularly when compared to multi-part mold silicone jamming grippers like those shown by Wall et al.

The layers may be constructed from 0.13 mm thick sheets of Mylar plastic, selected based on its use in previous research [13]. A single layer may be adhered to each segment of the gripper and sized so that they protrude from the base by an equal amount. With this configuration, the layers may overlap, meaning that the layer fixed at the tip sits on top of all other layers, preventing any from escaping through gaps in the constraint frame during actuation. One additional layer may be attached at the base of the gripper and fixed at its sides to allow the other layers to freely slide past it. This gripper may have 11 segments, so with the layer fixed at the base, a total of 12 layers may be used per finger. The rectangular cross section TPU jamming bag detailed in FIG. 2c may be placed inside the constraint frame and fixed at the tip of the gripper so it can slide in and out of the constraint frame with the jamming layers. With dimensions shown in FIG. 2, a gap (space not occupied by the jamming bag or layers) in the constraint channel may vary from 4.17 mm at the tip to 2.74 mm at the base, where all 12 jamming layers overlap.

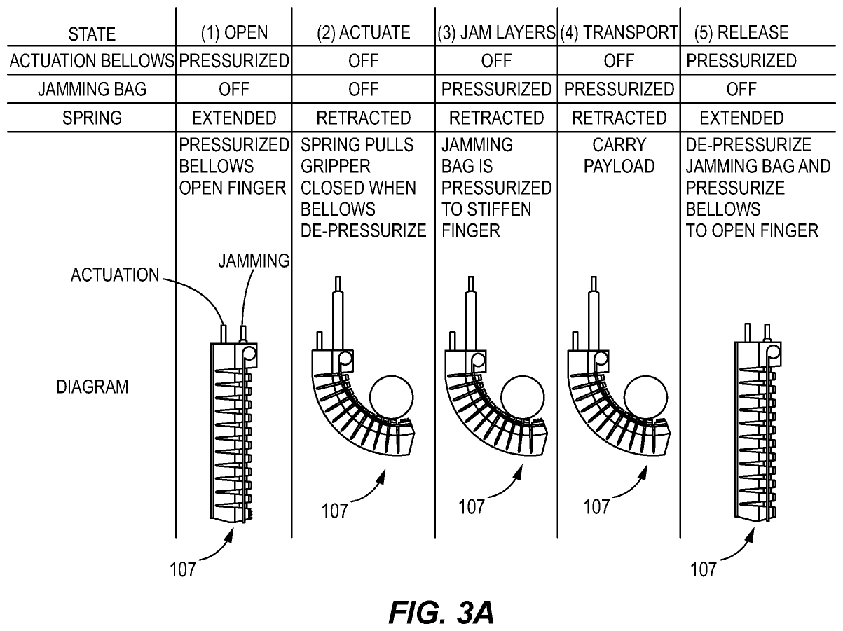

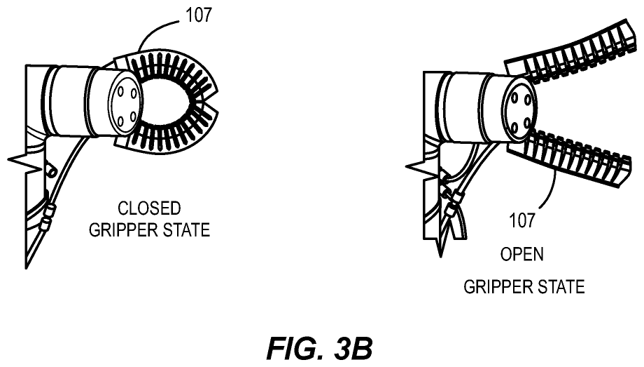

While most soft grippers require pressure to close on an object, and rely on material elasticity to open, this gripper may act in the opposite way. A 3.7 N constant force spring (McMaster-Carr 9293K113) may be fixed at the tip and base and used to pull the gripper into a curve, as seen in steps 2-4 of the cycle shown in FIG. 3. While this force is relatively low, similarly sized springs are available up to 10.2 N of force, so grip strength can be readily adjusted and increased. A common inflatable bellows actuator similar to those shown by Mosadegh et al. may be used to act against the spring and open the gripper into its straight state [10]. With this design, the layers can be placed opposite the bending axis of the gripper to maximize their effect on stiffness change. Because the jamming layers are placed on the inside radius of the gripper, they are placed in tension when under load, thus avoiding the layer buckling failure mode observed in other research [13].

Manufacturing Methods

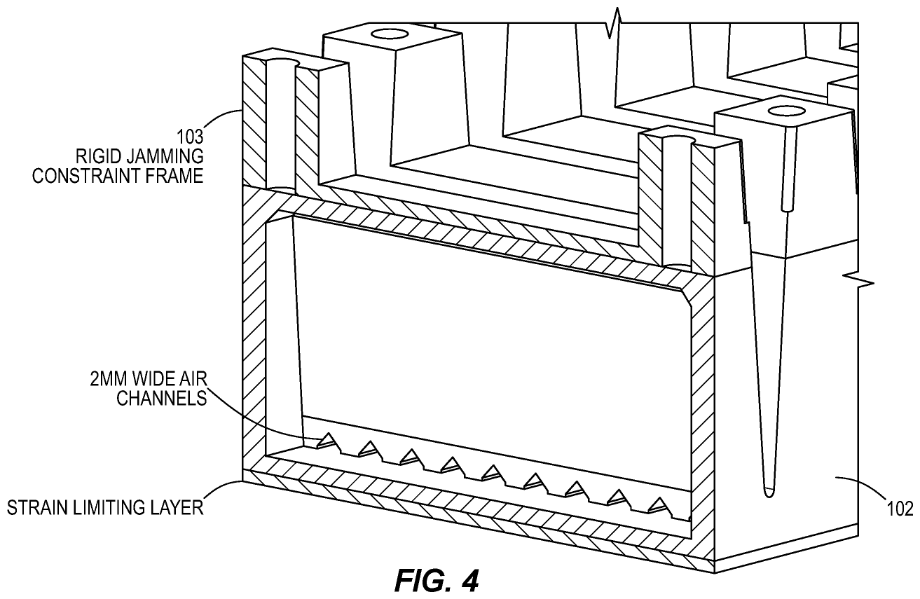

Most current research on soft pneumatic actuators utilize a silicone molding process to produce prototypes, frequently with 3D printed molds. While this process is effective, it often requires significant post processing and cannot be easily used to produce airtight actuators with complex internal geometry. In the design of the present gripper, multi-material 3D printing was used to significantly reduce post processing time and reliably produce small internal features. For example, soft grippers commonly use a piece of paper or plastic glued into the actuator as a strain limiting layer [10] [6]. As shown in FIG. 4, this can simply be printed with the actuator in one process. Also printed in place and shown in FIG. 4 is the rigid constraint frame, a hard plastic feature that would need to be glued onto a silicone actuator. Finally, the small 2 mm air channels shown in FIG. 4 would be difficult to reliably mold but can be easily produced with 3D printing.

Using customized additive manufacturing to produce soft actuators does, however, introduce other challenges. While the softest commercially available FDM filament has a hardness of 60 A, molding silicones are commonly available as soft as 10 A shore hardness. While the actuator designs were not identical, 28 A silicone actuators have been found to withstand up to 106 actuation cycles, with similar 3DPrinted 85 A TPU actuators failing at 600 cycles [10] [11]. Additionally, reliably printing soft filament requires specialized hardware and low print speeds. The print parameters used to produce this finger can be found in Table I.

TABLE I
3D Printing Parameters

| Parameter | TPU 85A | PETG |
|---|---|---|
| Nozzle Temperature | 225° C. | 250° C. |
| Bed Temperature | 85° C. | 85° C. |
| Volumetric Flow | 1.5 mm³/s | 7.5 mm³/s |
| Layer Height | 0.2 mm | 0.2 mm |
| Extrusion Width | 0.4 mm | 0.4 mm |
| Infill | 100% | 100% |
| First Layer Speed | 12 mm/s | 12 mm/s |
| Perimeter Speed | 20 mm/s | 20 mm/s |
| Cooling Fan | 100% | 15% |

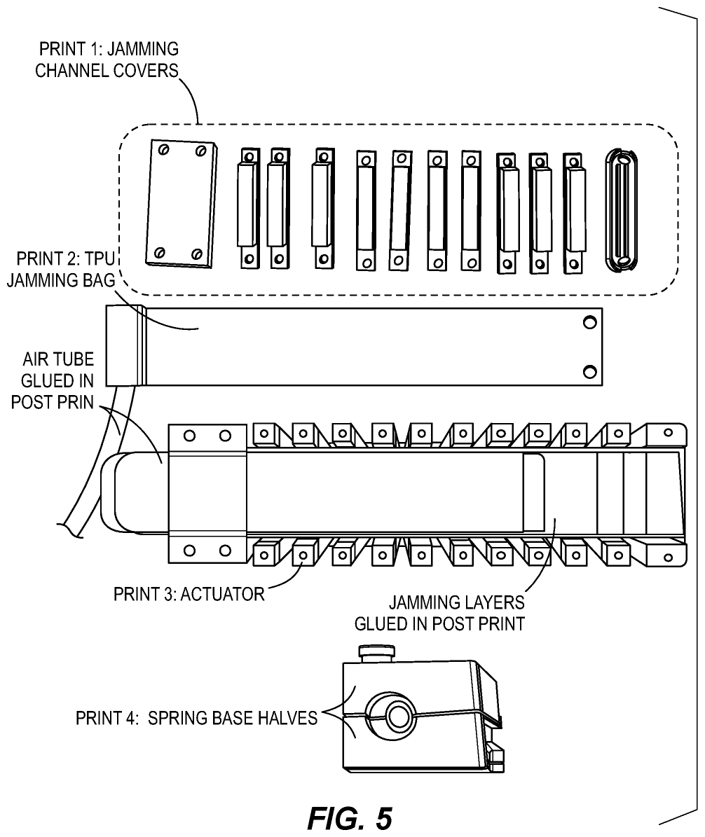

Producing the gripper presented here may require four prints and minimal post-processing. Multi-material prints are most reliably airtight when the divisions between materials are planar, so that the print heads do not need to be switched for every layer of material. Because of this fact, while it would be possible to produce all components with one print, the prints were divided as shown in FIG. 5 to maximize reliability. The main body of the gripper may be designed to accommodate this, requiring only two automated print head switches throughout the print: PETG to TPU to print the bellows on top of the strain limiting layer, and TPU to PETG to print the lower half of the jamming constraint frame on top of the bellows. After printing, air tubes may be glued into the TPU jamming bag and gripper, and mylar jamming layers cut to the width of the jamming frame may be glued to each segment of the actuator. Finally, screws may be used to fasten the spring mount covers, TPU bag and actuator together.

Testing and Results

Gripper Stiffness

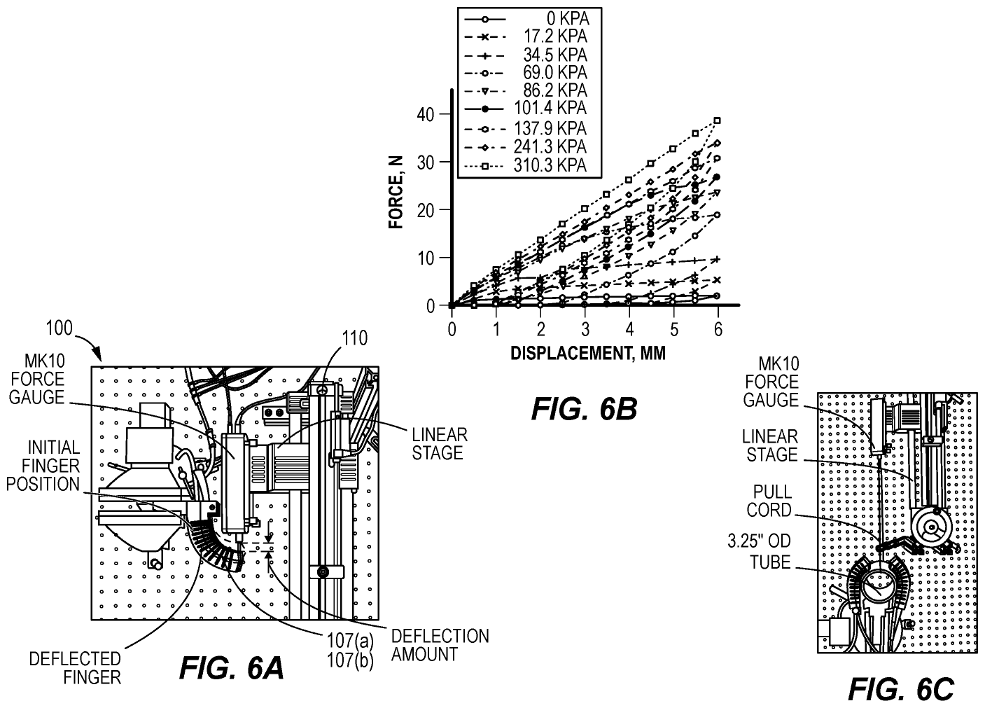

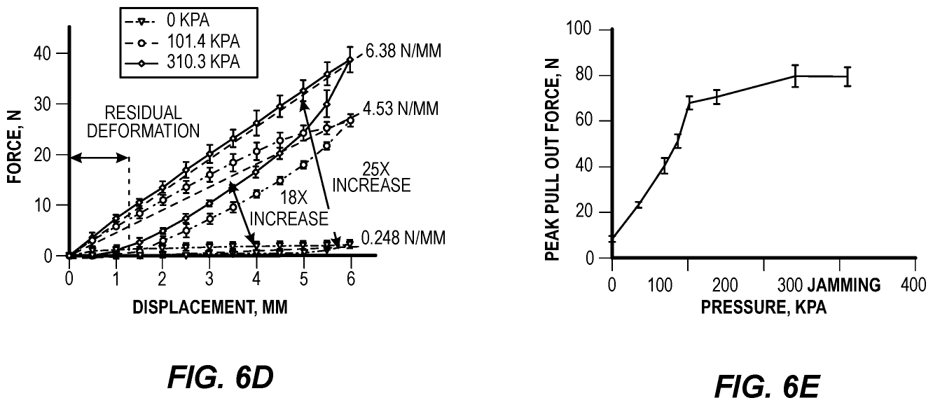

To test the stiffness of the gripper at different jamming pressures, the gripper was fixed to a rigid base and allowed to fully retract into a curve, then deflected using a force sensor mounted to a linear stage, as shown in FIG. 6a. The gripper was deflected by 6 mm, then allowed to return to its initial position. This was repeated five times at each pressure, and by plotting the recorded force and displacement, the stiffness of the gripper at different pressures can be compared.

Based on the plotted averaged force-displacement data in FIG. 6b, gripper stiffness is roughly saturated for the first 2 mm of deflection at a jamming pressure of 10 psi (69.0 kPa). Despite this, in FIG. 6b, it can be seen that average gripper stiffness increases with every increase in pressure, although the rate of increase does slow. While gripper stiffness at 10 psi (69.0 kPa) is comparable to higher pressures at low displacements, it begins slipping around the 2 mm of deflection, while at 45 psi (310.3 kPa) no distinct slip is seen over the entire 6mm range. To compare with vacuum layer jamming, one can examine finger stiffness at 14.7 psi (101.4 kPa) of jamming pressure, which should be equivalent to a similar finger jammed with best case (limited to atmospheric pressure) vacuum pressure of −14.7 psi (101.4 kPa). In layer jamming, pressure is applied to the layers to increase friction force. Pressurizing the jamming bag to “vacuum pressure” should compress the layers with the same pressure as vacuum jamming. This comparison can be used to demonstrate that increasing the pressure on the layers beyond “vacuum pressure” can further increase joint stiffness and performance.

In FIG. 6d it is clear that jamming the finger at 45 psi (310.3 kPa) offers a performance increase over vacuum-equivalent jamming at 14.7 psi (101.4 kPa)- average stiffness increases by 1.85 N/mm and the 45 psi (310.3 kPa) curve exhibits a constant slope, while the 14.7 psi (101.4 kPa) curve shows a distinct stiffness decrease at 4.5 mm of deflection, indicating significant slip. The similarly sized vacuum layer jamming grippers produced by Wall et al. showed a stiffness increase of 8× with 12.3 psi (85kPa) vacuum pressure, comparable to a recorded stiffness increase of 13× produced at 12.5 psi (86.2 kPa) vacuum equivalent jamming [6].

The force-deflection data can also be used to analyze hysteresis of the gripper, with the metric of residual deformation after loading (hysteresis) as defined in FIG. 6d. This was measured by finding the point where force from the force sensor drops to zero as the gripper is unloaded. This hysteresis originates from the jamming layers slipping relative to each other under deformation. Once the force is removed, the gripper is locked into the new deformed position. During testing at lower pressures it was found that hysteresis was extremely inconsistent. This is because stiffness at low jamming pressure is sensitive to the unpredictable nature of stiction between the layers. However once 35 psi (241.3 kPa) was reached, the layers appear to remain in Phase 1 (no slip) [13] and hysteresis was consistently near zero. More future research is necessary to fully characterize this behavior.

Pull-Out Force

To better quantify the gripper's real world performance, it was also tested for pull-out force with two of the fingers assembled into a gripper. Pull-out force is defined here as the peak force required to pull an object out of the grasp of the two finger gripper. In this test, a cardboard tube was grasped by the gripper with a cord looped through it attached to a force gauge mounted on a linear stage, as shown in FIG. 6c. The force sensor was traversed away from the gripper until the tube was fully removed from its grasp. This was repeated five times at a range of pressures, and average peak force can be seen in FIG. 6e. This test further demonstrates the advantage of positive layer jamming, as pull-out force increases above 12.5 psi (86.2 kPa), the limit for many low cost vacuum generators. The payload capacity increased until it saturated at 35 psi (241.3 kPa) with an average force of 80N . This is a 1.6× increase in force from 12.5 psi (86.2 kPa) and a 1.16× increase in force from 14.7 psi (101.4 kPa). Once adequate pressure is applied to the jamming layers, their stiffness in the Phase 1 (no slip) regime will not increase further [13]. Because the layers do not slip relative to each other in Phase 1, the overall stiffness of the gripper is dependent on the geometric and material properties of the gripper and layers. At lower jamming pressures, the deformation required to remove the tube may cause the jamming layers to slip and enter Phase 3, resulting in a lower pull-out force. However as jamming pressure increases, the deformation required to cause layer slip increases beyond the deformation required to remove the tube, causing payload to saturate. To further increase pull-out force, gripper design could be optimized to increase stiffness in the Phase 1 regime.

There is slightly higher standard deviation at higher pressures, but this can likely be attributed to the unpredictable nature of both the layers slipping relative to each other and the cardboard tube slipping against the finger as it is pulled out. Liu et al. showed testing of a similarly sized soft variable stiffness gripper with vacuum fiber jamming [9]. Their gripper design utilized three radially symmetric fingers and in similar pull out testing was able to achieve a peak pullout force of 12 N at 13 psi (90 kPa) of vacuum jamming pressure [9]. In the commercial space, the mGrip Soft Gripper from Soft Robotics Inc. advertises pickable object masses of up to 3.4 g, or 33.35 N with a 6 finger configuration and no variable stiffness technology from mGrip™. While the testing methodology for this metric is unknown, our design demonstrates a 2.4× increase in pull-out force compared to the 6 finger mGrip™ gripper.

Actuation

Several aspects of gripper actuation were tested, including repeatability of gripper tip position, gripper actuation speed and pressure required to fully open the gripper. Gripper tip position repeatability was measured using the linear stage & force sensor. The position of the gripper tip was measured before and after cycling it open and closed at 45 psi (310.3 kPa). In this testing, standard deviation of gripper tip position was 0.13 mm. This demonstrates that the gripper has adequate closing force to overcome any un-jammed friction and that its position can be reliably known for automation tasks. Actuation pressure, pressure required to fully open the gripper was also tested. In this test, the gripper was cycled with increasing pressure until it was fully open, which required 45 psi (310.3 kPa). While one finger opened fully at a lower pressure in testing, this is likely due to differences in assembly causing slightly more friction. Actuation time was then tested at 45 psi (310.3 kPa) using an electrically controlled solenoid and slow motion videos. Footage was then analyzed to determine open and close times. Using this method, recorded average open time was 0.24 s, and average close time was 0.29 s. These values are consistent in order of magnitude with other pneumatic gripper designs and adequate for real world uses [10]. While the gripper and jamming bag were both tested at pressures up to 60 psi (413.7 kPa), pressure for both was limited to 45 psi (310.3 kPa), the pressure required to fully open the gripper. This was chosen so that both could use the same air source, and in an attempt to minimize fatigue on both the gripper and jamming bag.

Functional Results

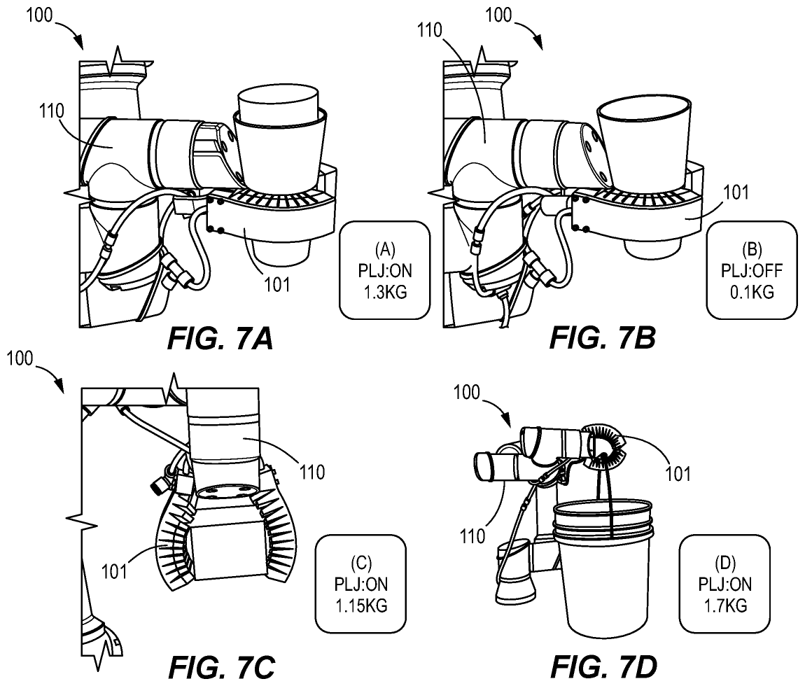

A base to integrate two fingers into a gripper was designed to test real world functionality. This gripper was installed as the end effector on a UR5 robot arm. Using solenoid valves connected to the UR5 control box, actuation and jamming pressure could be controlled in the UR5 software to pick up a variety of high weight payloads. The objects tested are shown in FIG. 7, and the variety demonstrates both the gripper's potential for heavy duty applications and its adaptability.

Conclusions and Future Work

A novel variable stiffness technology based on positive layer jamming was developed and integrated into a soft pneumatic gripper. The pull-out tests showed that the positive layer jamming has more than 1.6× payload than the traditional vacuum based layer jamming. The soft gripper produced in this research demonstrated a very high stiffness change with layer jamming activated. However, because the gripper was tested in the curved, gripping position, grip force was taken into account for the lower stiffness value. Because of this, stiffness change results are not directly comparable with results from vacuum layer jamming research on compliant links. In the future, a positive pressure jamming link will be designed and tested, independent of an actuator in order to optimize stiffness change performance. Parameters such as jamming channel dimensions, number of layers and layer material could be tested. Additionally, due to the inverted design of the actuator and use of an actuation spring, it has a relatively low grip force, limiting it to certain payloads. Future research could find a way to implement this positive jamming into a more standard gripper design to overcome this.

Customized multi-material additive manufacturing was used to rapidly iterate the soft gripper design. Multi-Material additive manufacturing also allowed for printed-in strain limiting features and hard points that would have otherwise required an additional assembly step. While optimized print parameters for airtight printing were developed over the course of this research, future work could be done to improve the robustness of the multi-material printing process to allow more complex geometries. Additionally, work should be performed to better characterize the fatigue life of actuators produced using this method.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment. The term “based at least in part on” and “based on” are synonymous terms which may be used interchangeably herein.

### REFERENCES

[1] D. Trivedi, C. D. Rahn, W. M. Kier, and I. D. Walker, “Soft robotics: Biological inspiration, state of the art, and future research,” Applied Bionics and Biomechanics, vol. 5, pp. 99-117, December 2008.
P [2] G. Alici, “Softer is Harder: What Differentiates Soft Robotics from Hard Robotics?,” MRS Advances, vol. 3, pp. 1557-1568, June 2018.

### [3] R. Zhao, Y. Yao, and Y. Luo, “Development of a Variable Stiffness Over Tube Based on Low-Melting-Point-Alloy for Endoscopic Surgery,” Journal of Medical Devices, vol. 10, p. 021002, June 2016.

[4] G. D. Howard, J. Brett, J. O'Connor, J. Letchford, and G. W. Delaney, “One-Shot 3D-Printed Multimaterial Soft Robotic Jamming Grippers,” Soft Robotics, p. soro.2020.0154, June 2021.

### [5] J. Choi, D.-Y. Lee, J.-H. Eo, Y.-J. Park, and K.-J. Cho, “Tendon-Driven Jamming Mechanism for Configurable Variable Stiffness,” Soft Robotics, vol. 8, pp. 109-118, February 2021.

[6] V. Wall, R. Deimel, and O. Brock, “Selective stiffening of soft actuators based on jamming,” in 2015 IEEE International Conference on Robotics and Automation (ICRA), (Seattle, WA, USA), pp. 252-257, IEEE, May 2015.
[7] X. Wang, L. Wu, B. Fang, X. Xu, H. Huang, and F. Sun, “Layer jamming-based soft robotic hand with variable stiffness for compliant and effective grasping,” Cognitive Computation and Systems, vol. 2, pp. 44-49, June 2020.

### [8] L. Blanc, A. Delchambre, and P. Lambert, “Flexible Medical Devices: Review of Controllable Stiffness Solutions,” Actuators, vol. 6, p. 23, July 2017.

[9] L. Liu, J. Zhang, G. Liu, Z. Zhu, Q. Hu, and P. Li, “Three-Fingered Soft Pneumatic Gripper Integrating Joint-Tuning Capability,” Soft Robotics, p. soro.2021.0082, October 2021.
[10] B. Mosadegh, P. Polygerinos, C. Keplinger, S. Wennstedt, R. F. Shepherd, U. Gupta, J. Shim, K. Bertoldi, C. J. Walsh, and G. M. Whitesides, “Pneumatic Networks for Soft Robotics that Actuate Rapidly,” Adv. Funct. Mater., vol. 24, pp. 2163-2170, April 2014.

### [11] H. K. Yap, H. Y. Ng, and C.-H. Yeow, “High-Force Soft Printable Pneumatics for Soft Robotic Applications,” Soft Robotics, vol. 3, pp. 144-158, September 2016.

[12] T. Hainsworth, L. Smith, S. Alexander, and R. MacCurdy, “A Fabrication Free, 3D Printed, Multi-Material, Self-Sensing Soft Actuator,” IEEE Robot. Autom. Lett., vol. 5, pp. 4118-4125, July 2020.
[13] X. Zeng, C. Hurd, H.-J. Su, S. Song, and J. Wang, “A parallel-guided compliant mechanism with variable stiffness based on layer jamming,” Mechanism and Machine Theory, vol. 148, p. 103791, June 2020.
[14] T. Liu, H. Xia, D.-Y. Lee, A. Firouzeh, Y.-L. Park, and K.-J. Cho, “A Positive Pressure Jamming Based Variable Stiffness Structure and its Application on Wearable Robots,” IEEE Robot. Autom. Lett., vol. 6, pp. 8078-8085, October 2021.
[15] J. R. Amend, E. Brown, N. Rodenberg, H. M. Jaeger, and H. Lipson, “A Positive Pressure Universal Gripper Based on the Jamming of Granular Material,” IEEE Trans. Robot., vol. 28, pp. 341-350, April 2012.
[16] J. Ou, L. Yao, D. Tauber, J. Steimle, R. Niiyama, and H. Ishii, “jamSheets: thin interfaces with tunable stiffness enabled by layer jamming,” in Proceedings of the 8th International Conference on Tangible, Embedded and Embodied Interaction—TEI '14, (Munich, Germany), pp. 65-72, ACM Press, 2013.
[17] R. Acevedo, L. Santos, R. D. Pedersen, N. Goyal, N. M. Bruck, S. K. Gupta, and H. A. Bruck, “Characterization and Modeling of Layer Jamming for Designing Engineering Materials with Programmable Elastic-Plastic Behavior,” Exp Mech, vol. 60, pp. 1187-1203, November 2020.

1. A finger for a robotic gripper, the finger comprising:
a flexible actuator having a proximal end, a distal end disposed opposite the proximal end, a first side, and a second side disposed opposite the first side;
a flexible backbone coupled to the flexible actuator and disposed along the first side of the flexible actuator;
a rigid constraint frame coupled to the flexible actuator and disposed along the second side of the flexible actuator;
a plurality of jamming layers coupled to the flexible actuator and disposed at least partially within the rigid constraint frame; and
a jamming bag disposed at least partially within the rigid constraint frame, the jamming bag configured to apply a compressive force to the jamming layers when a positive pressure is generated within the jamming bag.

2. The finger of claim 1, wherein the flexible actuator comprises a bellows.

3. The finger of claim 1, wherein the flexible actuator comprises:
an actuator base defining the first side of the flexible actuator; and
a plurality of actuator segments each extending from the base to the second side of the flexible actuator.

4. The finger of claim 3, wherein the actuator segments are arranged in series along the base in a direction from the proximal end to the distal end of the flexible actuator.

5. The finger of claim 3, wherein the flexible actuator further comprises a plurality of internal pockets defined therein, and wherein one of the internal pockets is defined within each of the actuator segments.

6. (canceled)

7. The finger of claim 3, wherein the flexible actuator further comprises a plurality of channels defined therein, and wherein one or more of the channels extends between the internal pockets of each adjacent pair of actuator segments.

8-10. (canceled)

11. The finger of claim 3, wherein the rigid constraint frame comprises a plurality of frame segments each coupled to one of the actuator segments, and
wherein the rigid constraint frame defines a channel extending in a direction from the proximal end to the distal end of the flexible actuator, wherein the jamming layers are disposed at least partially within the channel, and wherein the jamming bag is disposed at least partially within the channel.

12-13. (canceled)

14. The finger of claim 11, wherein the rigid constraint frame further comprises a plurality of frame covers each coupled to one of the frame segments and extending over the channel.

15-16.

17. The finger of claim 1, wherein the jamming layers are disposed between the jamming bag and the actuator.

18. The finger of claim 1, further comprising:
a guide layer coupled to the flexible actuator near the distal end of the flexible actuator and disposed between the jamming layers and the jamming bag;
a cover layer coupled to the flexible actuator near the proximal end of the flexible actuator and disposed between the guide layer and the jamming bag.

19-21. (canceled)

22. The finger of claim 1, further comprising a first air tube coupled to an air inlet of the flexible actuator and in fluid communication with a plurality of internal pockets of the flexible actuator, wherein the first air tube is configured to deliver air to and withdraw air from the internal pockets to actuate the flexible actuator.

23. The finger of claim 22, further comprising a second air tube coupled to the air inlet of the jamming bag and in fluid communication with an internal space of the jamming bag, wherein the second air tube is configured to deliver air to and withdraw air from the internal space to expand and contract the jamming bag.

24. The finger of claim 23, further comprising a pressurized air source in fluid communication with the first air tube and the second air tube.

25. The finger of claim 1, wherein the flexible actuator is configured to be actuated between a curved configuration and a straight configuration.

26-27. (canceled)

28. The finger of claim 1, further comprising an actuation spring coupled to the flexible actuator and configured to bias the flexible actuator toward a curved configuration.

29-30. (canceled)

31. The finger of claim 1, wherein the flexible actuator is configured to be actuated from a curved configuration toward a straight configuration when a positive pressure is generated within the flexible actuator.

32. The finger of claim 1, wherein the flexible actuator and the jamming bag are formed of at least one of a thermoplastic elastomer and a thermoplastic polyurethane, and
wherein the flexible backbone and the rigid constraint frame are formed of at least one of a thermoplastic polyester and a polyethylene terephthalate glycol.

33. (canceled)

34. A robotic gripper comprising:
a bellows;
a spring coupled to the bellows and biasing the bellows toward a curved configuration;
an air inlet coupled to the bellows and configured to provide positive bellows pressure to the bellows to actuated the bellows toward a straight configuration against the bias of the spring; and
a jamming bag coupled to and fluidly isolated from the bellows, and configured to provide a first stiffness of the robotic gripper at a first pressure and a second stiffness of the robotic gripper at a second pressure.

35. The robotic gripper of claim 34, wherein the robotic gripper is arranged in a soft curved configuration when the air inlet is not pressurized and the first pressure is provided to the jamming bag,
wherein the robotic gripper is arranged in a stiff curved configuration when the air inlet is not pressurized and the second pressure is provided to the jamming bag,
wherein the robotic gripper is arranged in a soft straight configuration when the air inlet provides the positive bellows pressure to the bellows and the first pressure is provided to the jamming bag.

36. A method of operating a robotic gripper, the method comprising:
biasing the robotic gripper toward a curved configuration with a spring;
providing positive bellows pressure to a bellows to actuate the robotic gripper toward a straight configuration against the bias of the spring; and
provide positive jamming pressure to a jamming bag to stiffen the robotic gripper.
